(19) United States
(12) Patent Application Publication
(10) Pub. No.: US 2014/0201608 A1
(43) Pub. Date: Jul. 17, 2014

(54) METHOD AND SYSTEM FOR GENERATING A DOCUMENT FROM MULTIPLE SOURCES

(71) Applicant: XEROX CORPORATION, Norwalk, CT (US)

(72) Inventors: Vinoth KUMAR Arputharaj, Tirunelveli Tamilnadu (IN); Nikesh Anand Rajagopalan, Chennai Tamil Nadu (IN)

(73) Assignee: XEROX CORPORATION, Norwalk, CT (US)

(21) Appl. No.: 13/743,625

(22) Filed: Jan. 17, 2013

(51) Int. Cl. G06F 17/21

(52) U.S. Cl. CPC G06F 17/21
USPC 715/202

(57) ABSTRACT

A method, system, and computer program product for extracting information from the Internet and generating a report on the basis of the extracted information are disclosed. A user can browse various websites, grab content of interest to him/her and assign notations to the information. Metadata corresponding to the selected information is stored in a database and can be retrieved by the user as and when desired to create a report corresponding to the selected information.

### TECHNICAL FIELD

The presently disclosed embodiments are related to a system and method for generating a document from multiple sources. More particularly, the presently disclosed embodiments are related to the system and method for extracting content from the Internet for further processing.

### BACKGROUND

The proliferation of the Internet has given access to information to billions of people around the world. Users can now access the Internet to gain access to a variety of information on various topics of interest to them. The overwhelming access to information, however, has created a problem of systematic retrieval and aggregation of the information. People us the information found on the Internet to prepare various research reports, case studies, study material, etc. However, there arises a problem of retrieving that information, annotating it if required, and presenting it in a user-friendly format for further processing.

### SUMMARY

According to embodiments illustrated herein, there is provided a computer implementable method for generating a report from one or more sources. The method includes selecting at least one of a text or an image in the one or more sources, wherein the selecting comprises performing a pre-defined action. Further, a set of metadata associated with the selected text or image is stored. A notation is assigned to the stored metadata, wherein the notation corresponds to at least one of unique file name or a folder name. Thereafter, the report is generated on the basis of the stored metadata and the notation.

According to embodiments illustrated herein, there is provided a system for generating a report from one or more sources. The system includes a user interface configured for receiving inputs from a user for selecting at least one of an image or a text from the one or more sources. Further, the user interface facilitates receiving inputs from a user for assigning notations to the at least one of an image or a text. The system further includes a cloud database configured for storing a set of metadata associated with the selected text or image and a report generator configured for generating a report on the basis of the notation and the stored metadata.

According to embodiments illustrated herein, there is provided a computer program product for use with a computer, the computer program product comprising a computer readable program code embodied therein for generating a report from one or more sources. The computer program product includes program instruction means for selecting atleast one of a text or an image in the one or more sources, wherein the selecting comprises performing a pre-defined action. Program instruction means are included to store a set of metadata associated with the selected text or image. Further, the computer program product includes program instruction means for assigning a notation to the stored metadata, wherein the notation corresponds to at least one of unique file name or a folder name. Lastly, the computer program product includes program instruction means for generating one or more reports on the basis of the stored metadata and the notation.

### BRIEF DESCRIPTION OF DRAWINGS

The accompanying drawings illustrate various embodiments of systems, methods, and other aspects of the invention. Any person having ordinary skills in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a flowchart illustrating a computer implementable method for generating a report from one or more sources, in accordance with an embodiment;

FIG. 2 is a snapshot illustrating the ‘mark’ option, in accordance with an embodiment;

FIG. 3 is a snapshot illustrating the annotating of marked information, in accordance with at least an embodiment;

FIG. 4 is a snapshot illustrating the generation of a report, in accordance with at least one embodiment; and

FIG. 5 illustrates a system for generating a report from one or more sources, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “one example”, “an example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

The following terms shall have, for the purposes of this application, the respective meanings set forth below.

‘Marking’ refers to a process of selecting information of interest from a website. In an embodiment, a user can browse multiple websites on the Internet and select the information, which interests him. Selecting the mark option enables saving the selecting information in to a database.

‘Annotating,’ refers to a process of modifying the information selected by the user. In an embodiment, the user can annotate the marked information to include his/her own comments/insights.

A ‘database’ refers to a storage space in which the marked information or the annotated information is stored. In an embodiment, the information selected and annotated by the user is stored in the database. The information selected by the user is stored in the database and is indexed in accordance with the nomenclature selected by the user. If the user has not defined a nomenclature for the information, then the database can assign file names to the stored information itself. The files names can be assigned on the basis of the URL of the website from where the information was selected, timestamp of the time at which the user selected the information, heading of the web page from where the user selected the information. It will be apparent to one skilled in the art that listed means of assigning names to the information selected by the user are only meant to serve as examples. Any other means of assigning file names to the selected information can be implemented without departing from the scope of the disclosed embodiments.

A “report” refers to a file, in an electronic form, that includes text/image portions. Examples of the electronic document may include, but are not limited to, emails, news articles, journals, or any other possible compilation of text and/or images. Further, the format of the report may include, but is not limited to, .doc, .docx, .ppt, .pptx, or .pdf. In an embodiment, the electronic document may include a text portion, an images portion, and/or both.

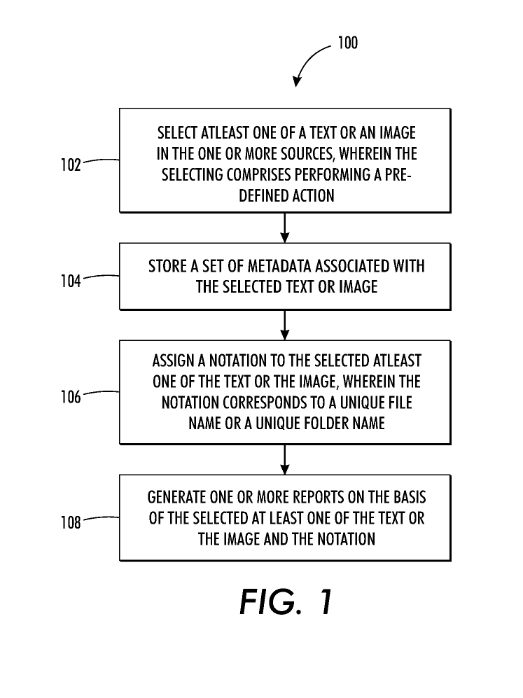

FIG. 1 is a flowchart illustrating a computer implementable method for generating a report from one or more sources, in accordance with an embodiment.

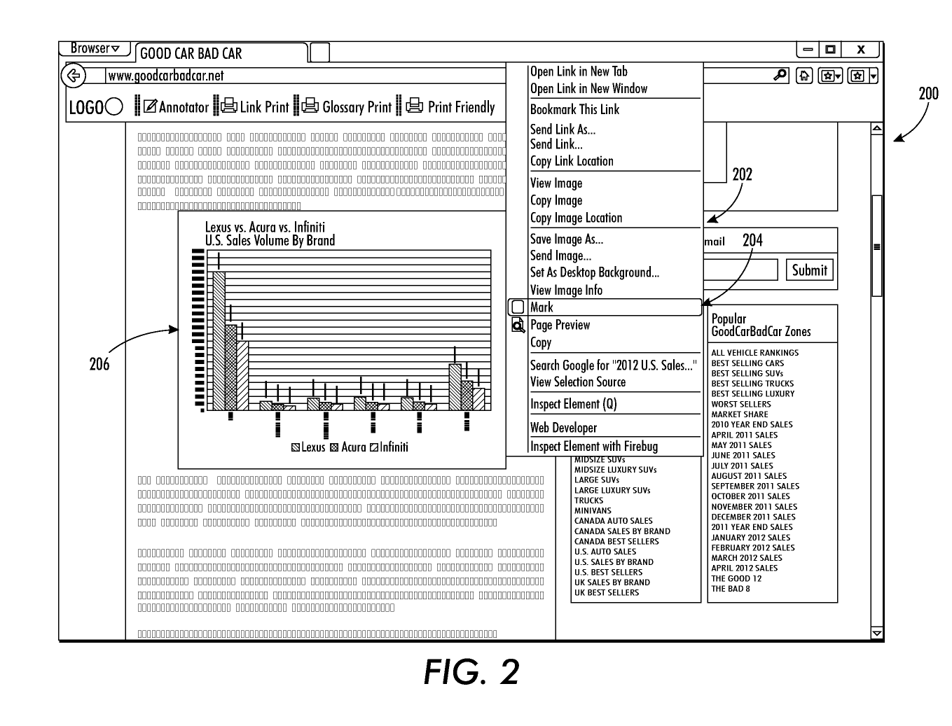

In an embodiment, a user visits a web page of interest to him/her. The user can access web pages on the Internet through any device, such as, but not limited to, a desktop computer, a laptop, a Personal Digital Assistant (PDA), a tablet, a smart-phone or the like. Once at the website, the user reviews the information of interest to him/her. At step 102, the user selects the information (text and/or image) of interest to him/her in accordance with a pre-defined action. In an embodiment, the pre-defined action corresponds to selecting the information of interest and using the right-click option through a mouse or a key-board to select a ‘Mark’ option. The process of marking will now be explained in detail in conjunction with the explanation for FIG. 2.

FIG. 2 is a snapshot illustrating the ‘mark’ option, in accordance with an embodiment. For example, in an embodiment, a user wishes to prepare a report on the auto industry. He/she visits a web site which can furnish relevant information such as major players, current market information and growth projections. The user selects the information of interest (206) on the web page. In an embodiment, the user can select the text/image of interest by pressing the left button on the mouse and dragging the cursor on his screen over the text/image of interest in order to select the information. In another embodiment, the user can select the information by using his keyboard. After selecting the information 206, the user presses the right button on the mouse, to open a list of options available to him/her. Menu 202 represents the set of options presented to the user upon using the right-click option on the mouse. 204 is the ‘Mark’ option, which the user selects to ‘mark’ the text and/or image he/she has selected on the web page. Information selected using the ‘mark’ option will hereinafter be referred to as marked information.

At step 104, a set of metadata associated with the selected text or image is retrieved and stored. In an embodiment, a set of metadata associated with the marked information is captured when the user selects the mark option. Metadata corresponds to information which can help identify the text and/or image which the user has selected. In an embodiment, the metadata corresponds to the URL of the website where the user has marked the information. In another embodiment, the metadata corresponds to the coordinates of the marked information. In an embodiment, the URL of the website along with the coordinates of the marked information are stored. Coordinates of the marked information refer to pointers which can help identify the location of the marked content on the website. At step 106, a notation is assigned to set of metadata associated with the marked information. In an embodiment, assigning a notation to the metadata corresponds to assigning a unique folder and/or file name to the set of metadata. In an embodiment, the user may be working on more than one report at a time. Hence, assigning a notation to the multiple sets of metadata collected from multiple marked information will help the user segregate the information on the basis of file name and/or folder name. Allocating a folder and/or filename also enables saving of the set of metadata in to a respective folder. In an embodiment, the set of metadata associated with the marked information is saved in a cloud database from where the user can retrieve the information whenever required. In an embodiment, whenever a user wishes to retrieve the stored content, the set of metadata is fetched and the marked information present at the coordinates in the set of metadata is retrieved. It will be apparent to a person having ordinary skill in the art that the set of metadata, post assigning a notation, can be saved at any location, such as a third-party server, or the user's computer etc. The storage of the set of metadata on the cloud database is only meant to serve as an example and not to limit the scope of the disclosed embodiments.

It will be appreciated by a person having ordinary skill in the art that the metadata corresponding to a particular text or an image will be stored and as and when the exact information changes at the location specified by the metadata, the stored metadata will accordingly correspond to the updated content. For example, if a user wants to track daily weather changes, he/she can visit a weather information website and mark the content which is of interest to him, such as temperature and weather forecast. The metadata corresponding to the location of these two pieces of information, temperature and weather forecast, will be stored. When the information stored at the coordinates specified by the metadata changes and the user retrieves the information through the metadata, he/she will get the most recent information available on the weather information website.

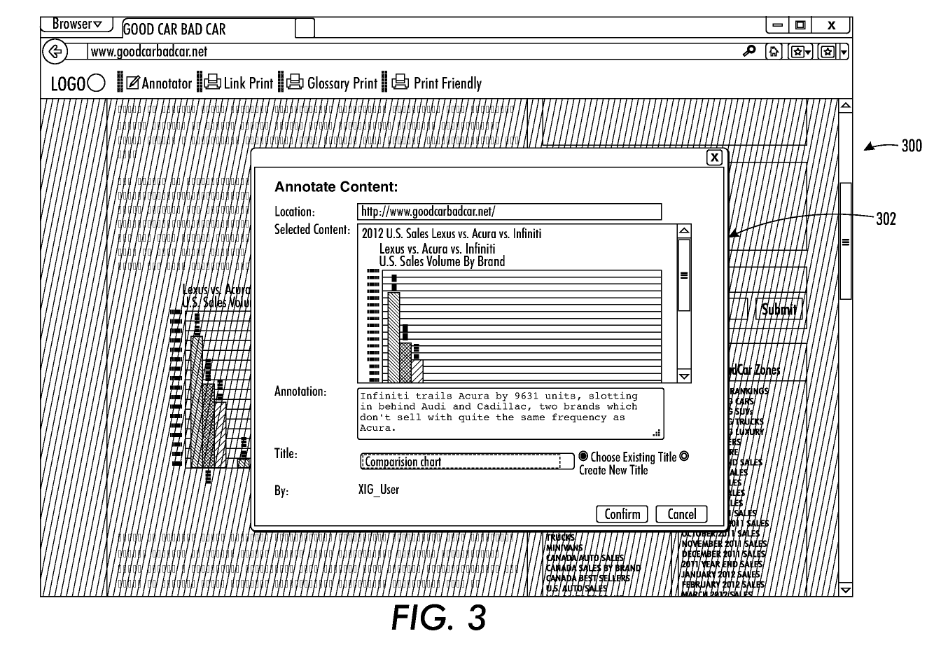

In an embodiment, the user can annotate the marked information depending upon his/her interests. Annotating the marked information will now be explained in more detail in conjunction with the explanation for FIG. 3.

FIG. 3 is a snapshot illustrating the annotating of marked information, in accordance with at least an embodiment. In an embodiment, the user can annotate the marked information depending on how the information is to be used. For example, in an embodiment, the user captures a chart depicting market outlook for the automobile industry. The user can then add his/her view as footnotes to the information. Annotate window 302 represents the annotating of marked information. The user can also use the annotate window 302 to add labels to the marked information such as chart title, etc. In an embodiment, the set of metadata associated with the annotated information is saved in the cloud database in to the folder created by the user. In another embodiment, the set of metadata associated with the annotated and marked information is saved in to the file specified by the user. In an embodiment, the set of metadata associated with the marked information is saved along with the additional information which has been annotated by the user. It will be understood by a person having ordinary skill in the art that the user can save multiple pieces of information by assigning suitable file and/or folder names for the information. By annotating the marked information, the user can create different reports/work outputs simultaneously.

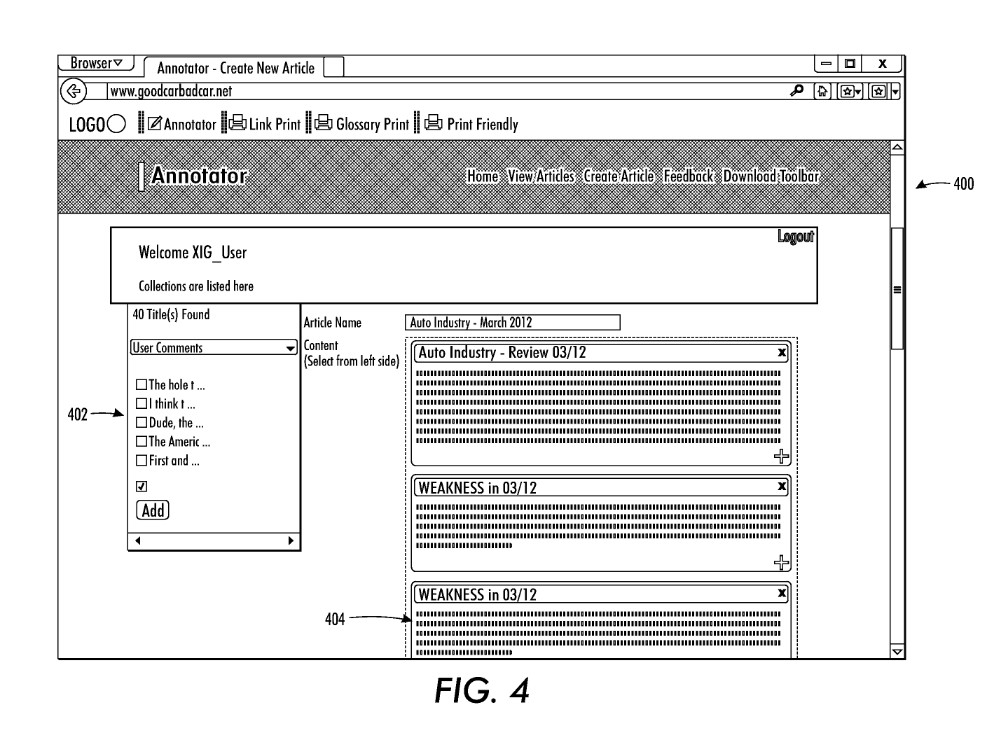

At step 108, a report is generated on the basis of the stored set of metadata. In an embodiment, the report is generated in accordance with the notation assigned to each folder and/or file. The step of generating the report will now be explained in greater detail in conjunction with the explanation for FIG. 4.

FIG. 4 is a snapshot illustrating the generation of a report, in accordance with at least one embodiment. In an embodiment, the user can choose to generate a report based on the set of metadata stored in the cloud database. 400 represents the window presented to the user when he/she wishes to generate the report. The user can select the format of the report to be generated by selecting an option from an option box (not shown). For example, in an embodiment, the user can choose to print the report in a PDF format. In another format, the user can choose to view the report in a HTML format. It will be apparent to a person having ordinary skill in the art that any format for generating the report, such as PDF, HTML, MS Word, etc, can be chosen without departing from the scope of the disclosed embodiments.

Further, the user can also input the comments which he/she had annotated post-marking the information. 402 represents the list of comments which the user had added as footnotes while annotating the information. While compiling the report, the user can select any number of comments from the list 402 to be added in to the final report 404. 404 is the final report, which is generated in the format specified by the user. In an embodiment, the sources from where the information have been collected is also included in the report 404. It will be apparent to a person having ordinary skill in the art that while collecting the information of interest, the sources from where the information has been selected is also retrieved as part of the set of metadata. These are combined with final report along with comments inputted by the user and the information selected by the user.

In an embodiment, the above disclosure does not rely on the type of programming language used to retrieve the stored content. It will be apparent to a person having ordinary skill in the art that the disclosed embodiments present a programming language-independent way to retrieve the stored information. The disclosed embodiments help a user save and retrieve information without the need to write separate program codes for the same.

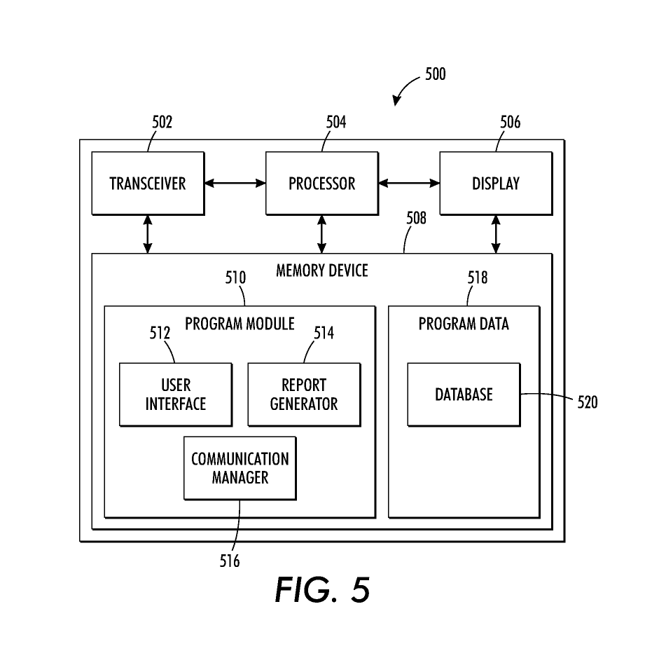

FIG. 5 illustrates a system for generating a report from one or more sources, in accordance with at least one embodiment. System 500 includes a transceiver 502, a processor 504, and a display 506. The transceiver 502, processor 504, and display 506 are interconnected to a memory device 508. The memory device 508 further comprises a program module 510 and program data 518. The program module 510 comprises a user interface 512, a report generator 514, and a communication manager 516. Program data 518 comprises a database 520.

The processor 504 is coupled to the transceiver 502, the display 506, and the first memory device 508. The processor 504 executes a set of instructions stored in the first memory device 508. The processor 504 can be realized through a number of processor technologies known in the art. Examples of the processor 504 can be, but are not limited to, X86 processor, RISC processor, ASIC processor, CISC processor, ARM processor, or any other processor.

A network (not shown) is used for the exchange of communication and messages between the system 500 and the Internet servers (not shown) through which the user accesses information of interest to him/her. Further, the network corresponds to a medium through which the content and the messages flow among various components (e.g., the database 520, the communication manager 516, and the Internet servers [not shown]) of the system 500. Examples of the network may include, but are not limited to, a Wireless Fidelity (WiFi) network, a Wireless Area Network (WAN), a Local Area Network (LAN) or a Metropolitan Area Network (MAN). Modules of system 500 can connect to the network in accordance with various wired and wireless communication protocols, such as Transmission Control Protocol and Internet Protocol (TCP/IP) User Datagram Protocol (UDP), 2G, 3G, or 4 G communication protocols.

The transceiver 502 transmits and receives messages and data to/from the communication manager 516. Examples of the transceiver 502 can include, but are not limited to, an antenna, an Ethernet port, a USB port or any port that can be configured to receive and transmit data from external sources. The transceiver 502 transmits and receives data/messages in accordance with various communication protocols, such as, Transmission Control Protocol and Internet Protocol (TCP/IP), User Datagram Protocol (UDP), 2G, 3G and 4 G communication protocols.

The memory device 508 stores a set of instructions and data. Some of the commonly known memory implementations can be, but are not limited to, random access memory (RAM), read only memory (ROM), hard disk drive (HDD), and secure digital (SD) card.

The communication manager 516 may transmit and receive messages/data in accordance with various protocols such as, but not limited to, Transmission Control Protocol and Internet Protocol (TCP/IP), User Datagram Protocol (UDP), 2G, 3G, or 4 G communication protocols.

The display 506 is interconnected to the processor 504 and is capable of displaying various information such as, but not limited to, videos, user interface, etc., to a user. The display 506 can be implemented using any known technology, such as, but not limited to, LED screens, LCD screens, OLED screens, AMOLED screens, etc.

In an embodiment, user interface 512 enables a user to browse the internet through the display 506. The communication manager 516 enables the user to access the websites on the Internet through the transceiver 502. In an embodiment, the websites are hosted by various servers located remotely from the user. The user can browse various websites on the internet and decide to save certain information pertinent to his interest or work. In an embodiment, while browsing a particular website, the user can mark certain information. The process of marking information has been explained in detail in conjunction with the explanation for FIG. 1. User interface 512 will enable the user to select the ‘Mark’ option from a menu 202. Post marking the required data, the user can annotate the selected information with his own insights/comments. The process of annotating the selected information has been explained in greater detail in conjunction with the explanation for FIGS. 1 and 3. Once the required information has been marked and annotated, the set of metadata associated with the marked information and the annotations included by the user are sent by the communication manager 516 to the report generator 514. In an embodiment, the set of metadata associated with the marked information is stored in the database 520. The user assigns a file name or a folder name to the selected information for accurate storage in the database 520. In an embodiment, the database 520 can be implemented using any known database implementation technique. In an embodiment, the database 520 can be stored locally. In another embodiment, the database 520 can be stored remotely from a user by implementing it in a cloud database.

The set of metadata stored in the database 520 can be retrieved at anytime by the user to access the marked information. In an embodiment, the user is assigned login credentials through which he/she can log in to the database and access the stored information.

The marked information pertaining to the stored set of metadata is sent by the communication manager 516 to the report generator 514 In an embodiment, the report generator 514, complies all of the information marked by the user (on the basis of the stored set of metadata and the notation) and generates a report. The process of generating the report has been explained in greater detail in conjunction with the explanation for FIGS. 1 and 4. The generated report is presented to the user through the display 506. The report generator 514 further stores the generated report in the database 520, from where the user can access the generated report at a later time. In an embodiment, the user can also change the format of the report after it has been generated. For example, in an embodiment, a user can choose to change the format of the generated report from a PDF document to a MS Word document.

In another embodiment, the user can also choose to generate a report from the sources located locally. For example, in an embodiment, the user can choose to browse multiple files, such as word document, Excel spreadsheets, power point presentations, etc., located on his/her computer. The user can access all the information through the user interface 512 viewed on the display 506. The information is compiled by the report generator 514 and presented to the user and/or stored in the database 520.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive and optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as LAN, MAN, WAN, and the Internet. The computer system facilitates inputs from a user through input device, accessible to the system through an I/O interface.

The computer system executes a set of instructions that are stored in one or more storage elements to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program, or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. Some of these advantages may include, but are not limited to, easily storing information of relevance from the Internet, annotating selected information with user inputs, and generating a report in a preferred format with all of the selected information. Further, the disclosed embodiments also include the sources of information in the report which helps the user avoid any copyright issues. Another advantage of the disclosed embodiments is enabling a tool to easily retrieve the information of interest without relying on any specific programming language. Even a user not versed with programming languages can use the disclosed embodiments to retrieve content easily from the Internet. Further, since the stored metadata corresponds to the location of the selected text/image and text/image is itself not stored, the user will receive the most up to date information at the location specified by the metadata whenever he/she retrieves the selected information. The disclosed embodiments present numerous advantages to researchers, scholars, academicians, consultants, etc., who have to scourge various websites for gathering information and presenting it to a larger audience.

Various embodiments of the method and system for generating a report have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art that are also intended to be encompassed by the following claims.

What is claimed is:

1. A computer implementable method for generating a report from one or more sources, the computer implementable method comprising:
selecting at least one of a text or an image in the one or more sources, wherein the selecting comprises performing a pre-defined action;
storing a set of metadata associated with the selected text or the image;
assigning a notation to the stored metadata, wherein the notation corresponds to at least one of a unique filename or a unique folder name; and
generating one or more reports on the basis of the stored set of metadata and the notation.

2. The computer implementable method of claim 1, wherein the one or more sources corresponds to at least one of a web page or an electronic document.

3. The method of claim 1, wherein the set of metadata comprises at least one of a URL of the one or more sources and a coordinate of the selected text or image.

4. The computer implementable method of claim 1 further comprising storing the notation and the set of metadata in a cloud database.

5. The computer implementable method of claim 1, wherein the generated report is at least one of a Portable Document Format (PDF) file, Word file, an Excel file, power point file, or a HTML report.

6. The computer implementable method of claim 1 further comprising presenting a list of options, wherein the list of options comprise at least one of a mark option.

7. The computer implementable method of claim 6, wherein the pre-defined action corresponds to selecting an option from the list of options.

8. The computer implementable method of claim 1, wherein the assigning further comprises inserting one or more comments.

9. The computer implementable method of claim 8, wherein the one or more comments are included in the generated report.

10. A system for generating a report from one or more sources, the system comprising:
a user interface configured for:
receiving inputs from a user for selecting at least one of an image or a text from the one or more sources; and
receiving inputs from a user for assigning notations to the at least one of an image or a text;
a cloud database configured for storing a set of metadata associated with the selected text or image and the notation; and
a report generator configured for generating a report on the basis of the notation and the stored metadata.

11. The system of claim 10, wherein the cloud database is further configured for storing one or more comments.

12. A computer program product for use with a computer, the computer program product comprising a computer readable program code embodied therein for generating a report from one or more sources, the computer readable program code comprising:
program instruction means for selecting at least one of a text or an image in the one or more sources, wherein the selecting comprises performing a pre-defined action;
program instruction means for storing a set of metadata associated with the selected text or the image;
program instruction means for assigning a notation to the stored metadata, wherein the notation corresponds to at least one of a unique file name or a unique folder name; and
program instruction means for generating one or more reports on the basis of the stored set of metadata and the notation.

13. The computer program product of claim 1 further comprising storing the notation and the set of metadata in a cloud database.

14. The computer program product of claim 1 further comprising presenting a list of options, wherein the list of options comprise at least one of a mark option.
